(19) United States
(12) Patent Application Publication
(10) Pub. No.: US 2009/0113042 A1
(43) Pub. Date: Apr. 30, 2009

(54) METHOD FOR CORRELATING PERIODICALLY AGGREGATED DATA IN DISTRIBUTED SYSTEMS

(75) Inventors: John A. Bivens, Ossining, NY (US); Rui Zhang, Oxford (GB)

Correspondence Address: MICHAEL BUCHENHORNER, P.A., 8540 SW 83 STREET, SUITE 100, MIAMI, FL, 33143, US

(73) Assignee: International Business Machines Corporaton, Armonk, NY (US)

(21) Appl. No.: 11/931,358

(22) Filed: Oct. 31, 2007

(51) Int. Cl. H04L 12/24

(52) U.S. Cl. 709/224

(57) ABSTRACT

A computer-implemented method for computing distributed component lag times includes: determining a transaction path for groups of transactions in a plurality of transactions to be processed; determining a distribution of elapsed times from a start of work at each component to an end of work at each component for the plurality of work processing components in the transaction path; determining a distribution of the offsets between the completion of work at the last component of the transaction path and the time of reporting the work at the last component of the transaction path; and combining the distributions of component elapsed times and the distribution of component offsets to calculate the transaction lag for each component in the transaction path.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of distributed information processing systems and more particularly relates to the field of computing distributed component lag times.

### BACKGROUND OF THE INVENTION

Monitoring is essential to maintaining the availability, performance, and security of computer systems. Many modern distributed systems, from the prevalent multi-tier commercial systems to the emerging service-oriented environments, are transaction-oriented. As these systems grow in size and span in geographical/organizational terms, user requests (i.e. transactions) must be traced through an increasingly larger set of components to ensure their quality of service (QoS) goals are met.

Resulting data such as the transaction time spent on a component, transaction success/failure rates, and resource usage statistics are collected from a (potentially) large number of distributed sources, and often reported to a central location for critical management activities including problem localization and remediation, performance analysis and predictions, and closed-loop resource provisioning. In order to perform these tasks with system-wide QoS goals in mind, data collected from different components must be correlated in an end-to-end manner.

This correlation can be done at a per transaction level, either by floating a unique ID alongside each transaction across instrumentation points and binding component metrics to a particular transaction, or using temporal relations among data associated with a transaction. While per transaction correlation facilitates micro understanding and control of system behaviors, it risks flooding the network with monitoring data and imposing significant overhead such as 8.4% for a web application

To overcome this potentially prohibitive shortcoming, other efforts batch component data and report their aggregate (e.g. average elapsed time) at the end of pre-selected intervals. Periodic reporting of aggregated data largely reduces the resulting network flow, and makes the monitoring mechanism more affordable in heavily loaded environments and more employable by on-line tuning/analysis processes. However, since transaction IDs are lost during aggregation, aggregated data from different components are currently correlated according to the intervals in which they are reported.

Due to the “lag” in time for a transaction to go from an up-stream component to a down-stream component, measurements taken at these two components for the same transaction may not be reported at the same interval. In other words, data reported from different components and correlated based on intervals may not have been drawn from the same group of transactions. This mismatch can be misleading when it comes to key autonomic functions including root cause analysis of slow end-to-end response time and response time prediction.

### SUMMARY OF THE INVENTION

Briefly, according to an embodiment of the invention a method for computing distributed component lag times includes steps or acts of determining a transaction path for groups of transactions in a plurality of transactions to be processed; determining a distribution of elapsed times from a start of work at each component to an end of work at each component, for the plurality of work processing components in the transaction path; determining a distribution of offsets between the completion of work at the last component of the transaction path and the time of reporting the work at the last component of the transaction path; and combining the collective distributions of component elapsed times and the distribution of component offsets to calculate the transaction lag for each component in the transaction path.

The method can also be implemented as machine executable instructions executed by a programmable information processing system or as hard coded logic in a specialized computing apparatus such as an application-specific integrated circuit (ASIC).

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a diagram illustrating the components in an exemplary three-tier distributed system and the path a transaction takes in the form of a sequence of requests and responses between neighboring components, according to an embodiment of the present invention;

FIG. 2 is a diagram illustrating the time a transaction elapsed on each component in an exemplary distributed system.

FIG. 3. is a diagram depicting the offset between the moment when a transaction terminates in an exemplary distributed environment and the moment when the overall statistics regarding the transaction is reported at the end of the data reporting interval;

FIG. 4 is a diagram illustrating the transaction lag for each message of a transaction in an exemplary distributed system, according to an embodiment of the present invention;

FIG. 5 is a flowchart of a general lag computation algorithm;

FIG. 6 illustrates lag computation in a relatively simple three tier scenario, according to an embodiment of the present invention;

FIG. 7 demonstrates lag computation in an alternate scenario, according to an embodiment of the present invention; and

FIG. 8 is a high-level flow chart of the processing steps for a method according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Correlating periodically aggregated data properly is essentially a problem of identifying the actual intervals at which the data for a transaction is reported on different components, despite the data reporting lags. We describe a computer implemented method for computing distributed component lag times using workflow information and the lag times of downstream or upstream components. A data reporting lag is the lag in time between the moment when the transaction terminates and the instant at which the transaction's (sub) response/request leaves any hop j. Using reference intervals, the data reporting lag is the sum of the following two offsets:

the Reporting Offset O—the distance between the moment when the final transaction response leaves the distributed system (final transaction completion) and the ending instant of the reference interval;

the Transaction Lag TL—the lag between the moment when the final transaction response leaves the distributed system (final transaction completion), and the moment when the corresponding (sub) request/response leaves any hop j. This value is the accumulation of Per-hop Request/Response Lags (the time taken to process requests/responses at any hop k (k=2, 3, . . . , j−1) in between hop 1 and j.

Each node of the system is ordered by the reverse path transactions take. These values are used in a recursive manner, updating each hop level lag based on the same values of downstream systems. Because of the recursive manner of this process, it can be easily implemented. This procedure will make current dynamic statistically driven systems management algorithms more precise and make detailed monitoring possible at low overheads.

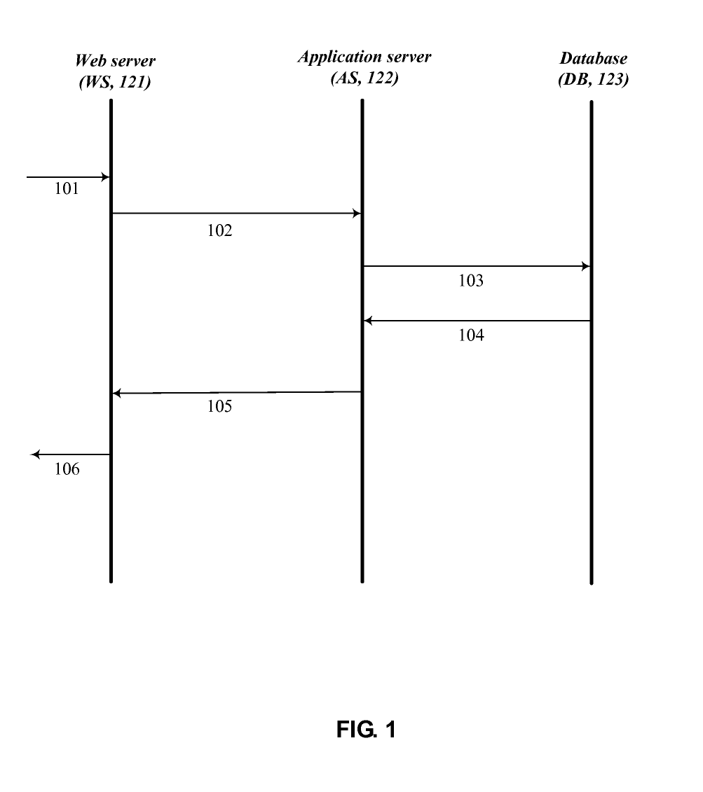

A typical example of a distributed system today is a commercial data center consisting of, but not limited to, three tiers of components: web servers 121, application servers 122, and databases 123 (other components also used are firewalls, accelerators, queuing components, proxies, and so on). In these environments, a user transaction typically touches one component on each tier, triggering a sequence of request/response messages 101-106 between neighboring components as shown in FIG. 1.

Referring now to the drawings and to FIG. 1 in particular, there is shown a diagram illustrating the components in an exemplary three-tier distributed system and the path a transaction takes in the form of a sequence of requests (denoted by the right-arrows) and responses between neighboring components.

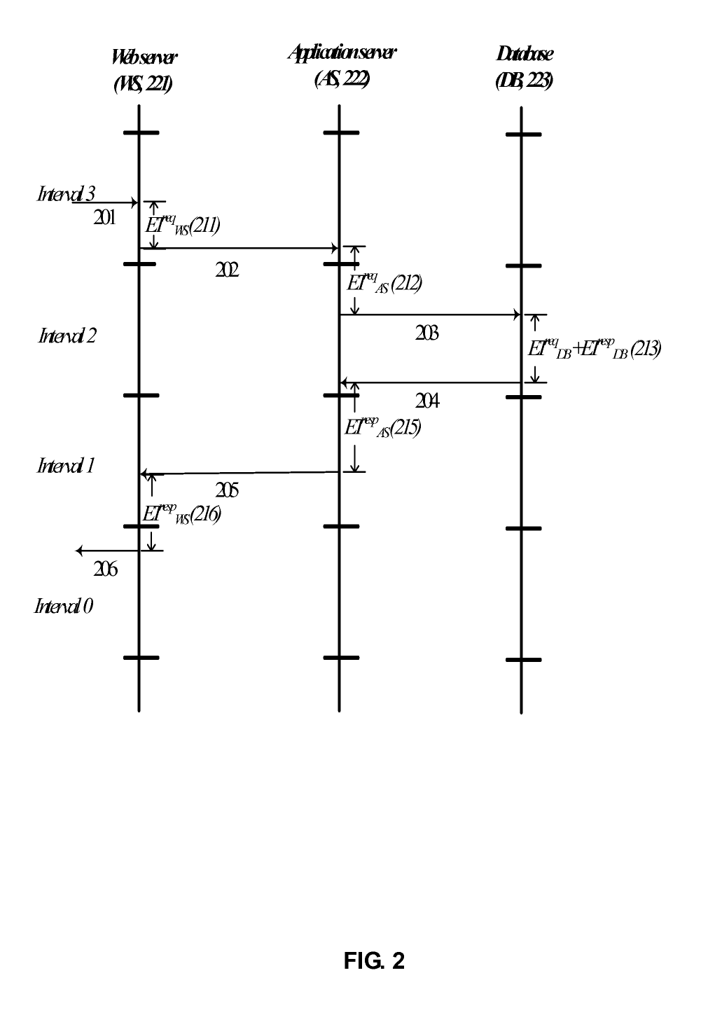

Referring to FIG. 2, there is shown a diagram illustrating the processing time per transaction elapsed on each component in an exemplary distributed system. This elapsed time consists of the component-based time it takes to process a request (ETₓ^{req}, where x is the component) and the time elapsed on processing and generating a corresponding response (ETₓ^{resp}, where x is the component).

FIG. 2 illustrates the component-based request and response processing time for a transaction on each tier in an exemplary three-tier distributed system like the one depicted in FIG. 1. These statistics are normally measured separately when the request and subsequent response departs from that tier. For example, at the application server 222, the incoming request 202 results in elapsed time measurement denoted by ET^{req}_{AS} 212 and the subsequent response 204 results in an elapsed time measurement denoted by ET^{resp}_{AS} 215.

There are exceptions such as the database tier 223, where no clear line may be drawn to separate the request and response processing time, and they are measured as a whole as in time 213. The data reporting lag across different hops can clearly be seen. ET^{req}_{WS}211 is aggregated and reported at interval 3, ET^{req}_{AS} 212, ET^{req}_{DB}+ET^{resp}_{DB} 213 at interval 2, ET^{resp}_{AS} 215 at interval 1, and ET^{resp}_{WS} 216 and the overall response time at interval 0. These four exact intervals must be identified in order for the elapsed time data to be correctly correlated.

Delays between these application components (e.g. network delays, and so forth) are integrated into this technique by treating the delay-causing component as any other workload handling component (it can be inserted as a component between any of the other components and measured accordingly).

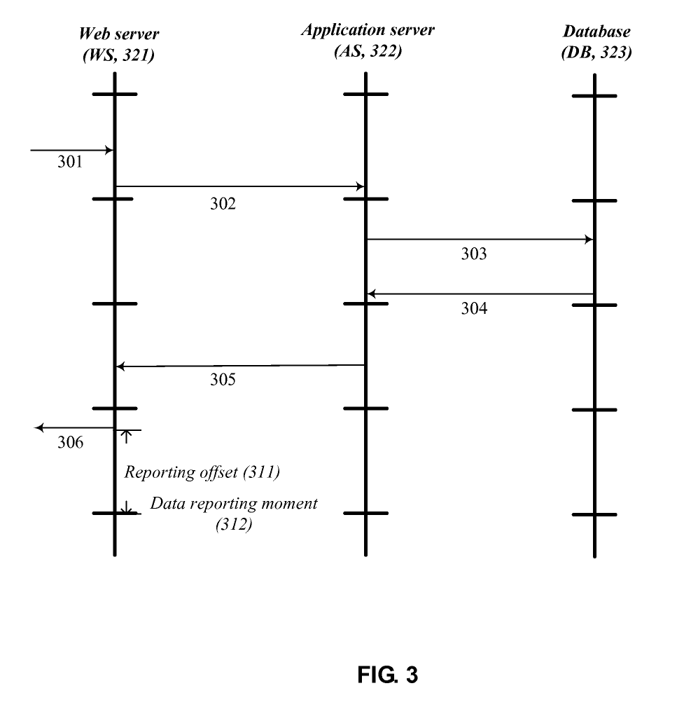

FIG. 3. is a diagram depicting the reporting offset 311 in a three-tier distributed system. It shows the offset between the moment when a transaction terminates (message [306], which is the overall response for the transaction) in an exemplary distributed environment and the moment when the overall statistics (e.g. end-to-end response time) regarding the transaction is reported at the end of the data reporting interval.

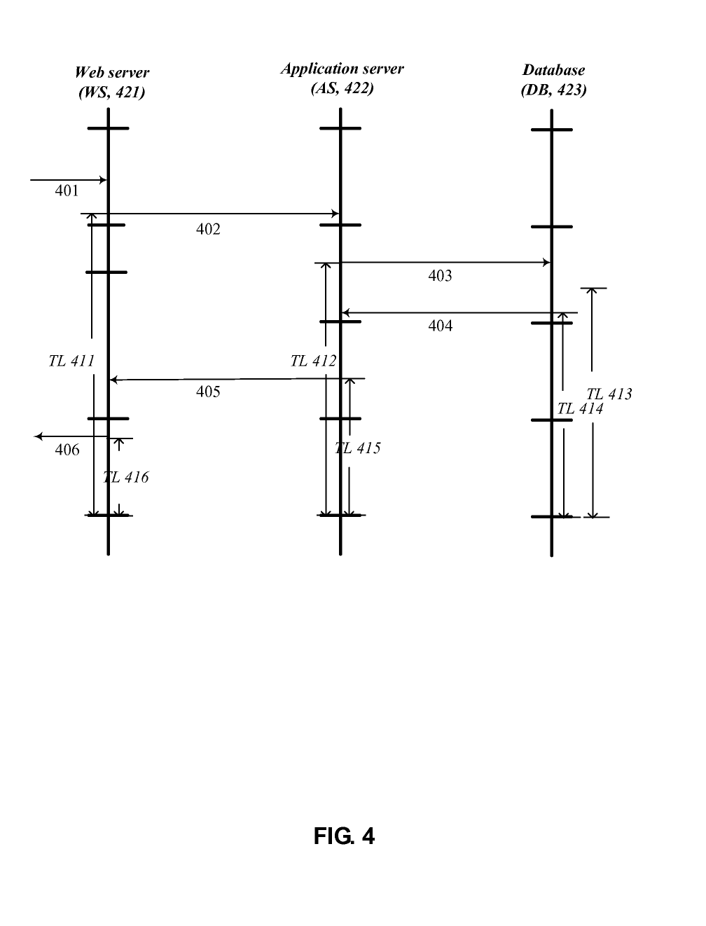

The offset is the time difference between the moment message 306, the final transaction response, leaves the system (via web server 321) and the ending instant 312 of the reference interval. The reporting offset accounts for the part of the lag (of any component in question) caused by asynchronization between transaction processing and aggregated data reporting, in contrast to the lag resulted from transaction processing alone (as in FIG. 4).

FIG. 4 is a diagram illustrating the transaction lag (TLᵢ) for each message i (request or response) of a transaction in an exemplary distributed system. FIG. 4 depicts the transaction lags TL 411-TL 416 for all messages (requests/responses) 401-406 of a particular transaction in an example three-tier distributed system. This is the lag between the moment when the final transaction response 406 is reported at web server 421, the moment when the corresponding (sub) request/response leaves the hop where it is processed/generated.

Each transaction lag is the accumulation (not necessarily a simple sum) of the hop level lags (i.e. time taken to process subsequent requests and generate subsequent responses for the transaction being considered). For instance, the transaction lag TL 411 (for the reporting of request 401) in the figure is the accumulation of the time elapsed to process requests 401, 402 and 403 as well as generate and process responses 404, 405 and 406.

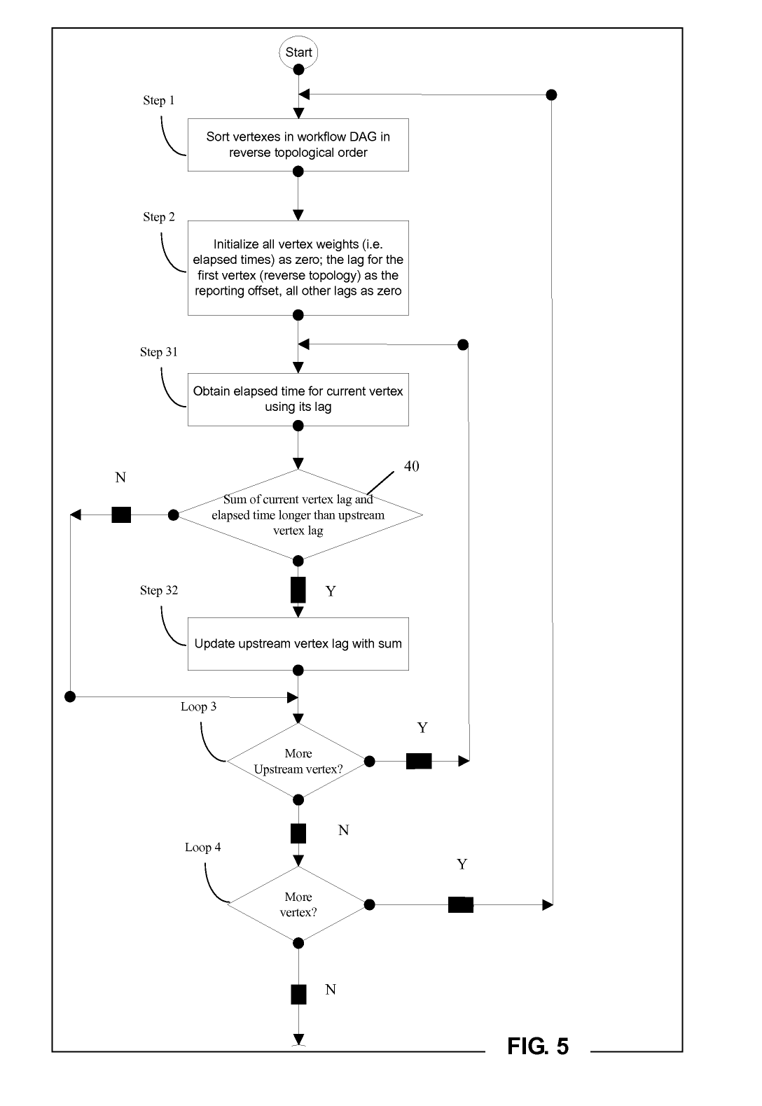

FIG. 5 is a flowchart of a general lag computation algorithm. The algorithm receives as input the reference (current) reporting interval, the reporting offset statistics, the workflow directed acyclic graph (DAG) and the aggregated data collected thus far. Two lag values are tracked for each vertex v: the transaction lag, L(v), which is the longest statistical path length the algorithm is designed to derive, and the per-hop request/response lag, W(v), which is the weight (per-hop lag) associated with v. Both quantities are statistical and in the form of probability distributions.

The method for lag computation relies heavily on the workflow DAG for the type of transaction and the environment concerned. We consider a workflow DAG where every vertex stands for the part of a component handling requests or responses and is annotated with the corresponding per-hop request/response lag time (i.e. elapsed time).

The lag assessment problem can be formalized as finding the statistically longest weighted path between the last vertex and any other vertex. A notable and necessary extension to the basic longest-path algorithm for DAGs is that the weights (i.e. the per-hop lag times) are not statically given at the outset, but obtained on-the-fly by locating the correct per-hop lag time information reported during past intervals using freshly computed transaction lags.

Referring again to FIG. 5, at the beginning of the algorithm (step 1), the vertices are first sorted in their reverse topological order. The longest path problem in a DAG is recursive, in that finding the longest path to any vertex v is equivalent to finding the longest path to all its successors and then taking the greatest sum of the lengths of these paths and the respective weights to connect them with v. The algorithm therefore traverses all vertexes in reverse topological order, ensuring all its successors have been covered when the lag for vertex v is assessed.

A second task at this beginning stage (step 2) sees the initialization of all weights (per-hop lags) and lags to be zero, except for the lag for the last vertex which is set to be offset O. This last assignment matches the fact that the actual elapsed time data for the last vertex is always reported in the transaction-terminating interval. This last vertex has no transaction lag and the only lag it suffers is the reporting offset.

As the execution proceeds into the main loop (loop 3), two types of computations repeatedly take place in alternate order: a weight (elapsed time, per-hop lag) update to the current vertex v (step 31) followed by a (transaction) lag update to each of its immediate upstream vertex u (step 32). The reason behind the alternation is that the computation of (transaction) lag, L(u), requires the weight for v, W(v), which requires L(v) to locate. Assessing L(v), in turn, depends on the weights (per-hop lags) of all its downstream nodes, and so on. If the sum of the current vertex lag and elapsed time is longer than the upstream vertex lag (40), then the upstream vertex lag has to be updated with that sum (32).

At the start of an outer iteration (Loop 3), L(v) will be holding the final lag value for v. This is because the transaction lags of all its successors will have been covered due to the way the workflow DAG is traversed, and used to update L(v), and the correlated per-hop lag data for v, W(v), can be located using L(v). The transaction lag, L(u), for every immediate upstream node u of v is then updated with L(v)+W(v), if L(v)+W(v) is statistically longer than the current L(u).

There are many ways to define this relationship such as P(L(v)+W(v)>L(u))>50%, or E(L(v)+W(v))>E(L(u)), and so on. The lag update ensures L(u) holds the latest statistically longest path value. Note that the correlation of elapsed time data will have already been completed during the course of weight updates in the algorithm.

The cycle repeats (Loop 4) if there are any more vertices to traverse, else the process ends.

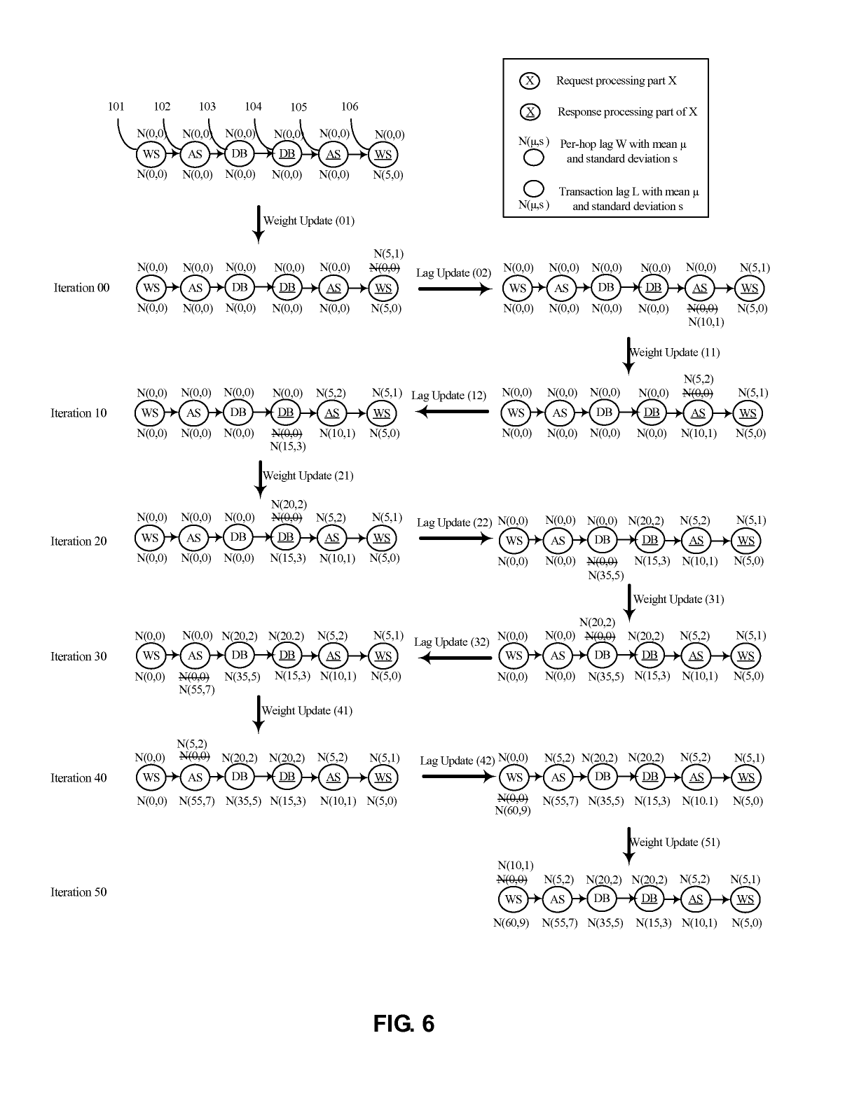

FIG. 6 illustrates lag computation in a relatively simple three tier scenario, where there is only one path from the last vertex of the workflow (where the transactions terminate) to each other vertex.

For demonstration purposes, all lags are assumed to follow form normal distributions N(μ, σ), where μ is the mean and σ is the standard deviation. All monitoring data collected (i.e. μ and σ values), and thus the weights, are engineered. The reporting offset is set to O=N(5,0). The lag assessment initializes all per-hop lags (shown above vertexes) and transaction lags (shown below vertexes) except for the lag for WS 106 to zero. The lag for WS 106 is initially set to O instead, as it is where the transactions terminate and data reported suffers from no transaction lag.

Firstly, as execution enters the iteration 00, we obtain the time elapsed on the web server response part WS 106, using L(WS₁₀₆)=N(5,0). We have the correlated elapsed time data for the web server response part (WS 106) as reported in the transaction-terminating interval (i.e. reference interval 0). The located data is used to perform a weight (per-hop lag) update 01 to the WS 106. Subsequently, a lag update step 02 is taken, as the response processing part of the application server (AS 105) is the only upstream node. Its lag is simply L(WS₁₀₆)+W(WS₁₀₆). The update patterns stated above repeat for AS 105 (iteration 10), DB 104 (iteration 20), DB 103 (iteration 30), AS 102 (iteration 40) and WS 101 (iteration 50), as they are traversed in reverse topological order.

As the algorithm concludes in iteration 50, the weight (i.e. per-hop lag) for the lastly visited node (WS 101) is located. The lags for all the nodes have been derived. In this regard, the weight location for the last node is not necessary if the application is not concerned with elapsed time, and there is no need for a lag update step for WS 101. The lag distributions produced can now be employed to correlate any data of interest to the application at the current interval, in much the same manner as the weights were located when the algorithm was executed.

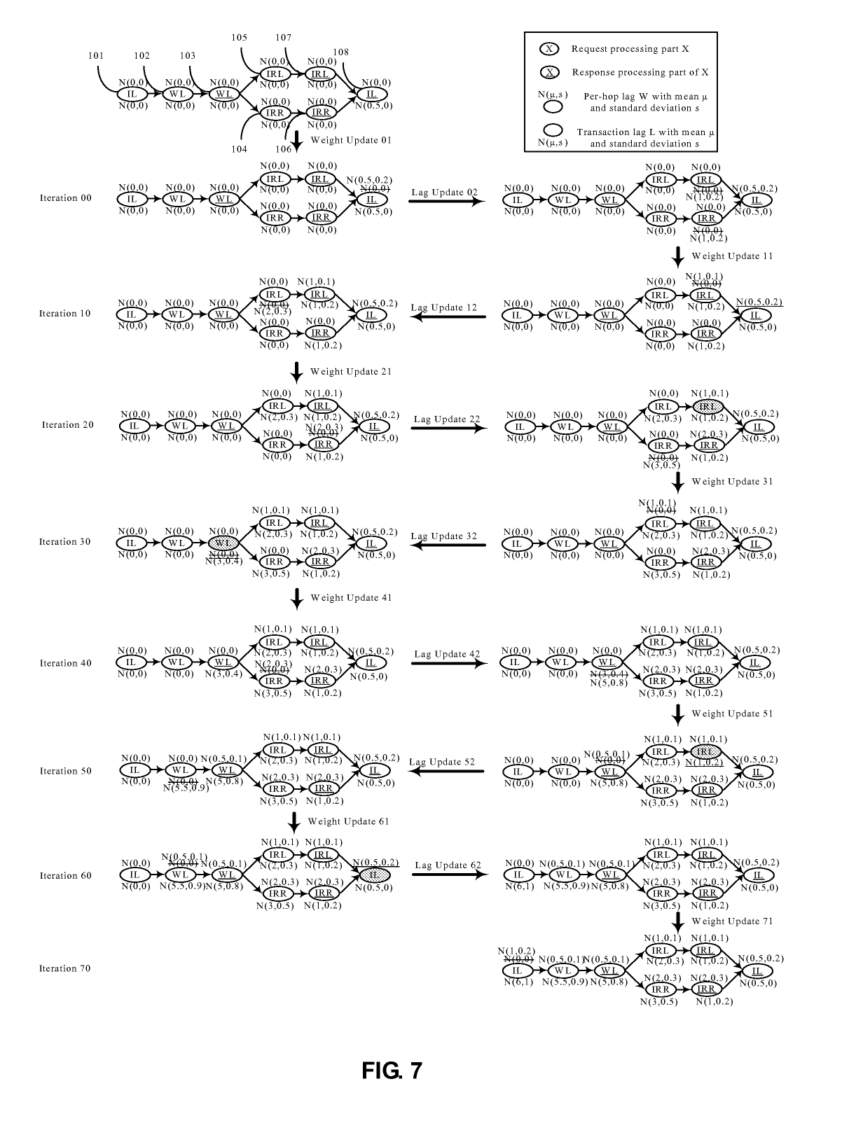

FIG. 7 demonstrates lag computation in a scenario which is more complicated in two ways. First, there can be more than one upstream node in the lag update phase, which means the inner loop of the algorithm may be executed more than once. Second, the last vertex of the workflow (IL 108) has more than one path to some of the nodes in the workflow, and the lag for each of these nodes is resulted from the statistically longest weighted path. For demonstration purposes, all values and subsequently the weights (i.e. per-hop lags) herein are, again, engineered, and the reporting offset is set to a constant O=N(0.5,0).

Iteration 00 is an example where the first complication occurs. After the weight update for IL 108, the lags for both IRL 107 and IRR 106 are updated in the inner iteration, as both lags consist of the per-hop lag (i.e. weight) on IL 108.

The second complication arises during the lag assessment for the response part of WL 103. During the lag update phase 32, WL 103 is updated with the lag via path IL 108-IRL 107-IRL 105 which is L(IL108)+W(IL108). Later on in iteration 40, however, this lag is replaced by a statistically longer one through path IL 108-IRR 106-IRR 104. This latest lag is used to find the elapsed time data for WL 103.

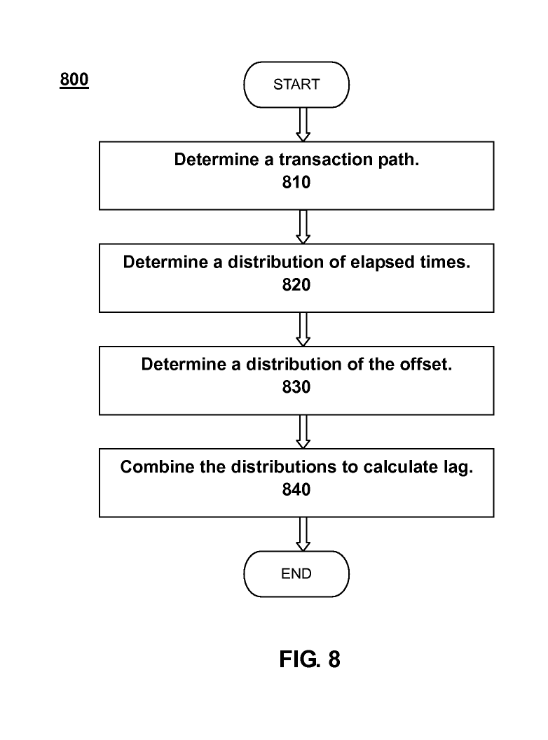

FIG. 8 is a high-level flowchart 800 of the processing as described above. The process begins at step 810 by determining a transaction path for groups of transactions in a plurality of transactions to be processed. Next, in step 820 processing proceeds by determining a distribution of elapsed times from the start of work at each component to the end of work at each component, for the plurality of work processing components in the transaction path.

Step 830 proceeds by determining a distribution of the offset between the completion of work at the last component of the transaction path and the time of reporting this work at the last component of the transaction path. Finally, in step 840 the collective distributions of component elapsed times and the distribution of component offsets to calculate the transaction lag for each component in the transaction path are combined.

Therefore, while there has been described what is presently considered to be the preferred embodiment, it will understood by those skilled in the art that other modifications can be made within the spirit of the invention. The above description of an embodiment is not intended to be exhaustive or limiting in scope. The embodiment, as described, was chosen in order to explain the principles of the invention, show its practical application, and enable those with ordinary skill in the art to understand how to make and use the invention. It should be understood that the invention is not limited to the embodiments described above, but rather should be interpreted within the full meaning and scope of the appended claims.

1. A computer-implemented method for computing distributed component lag times for a plurality of transactions comprises:
determining a transaction path for groups of transactions in the plurality of transactions to be processed;
determining a distribution of elapsed times from a start of work at each component to a completion of work at each component, for the plurality of components in the transaction path;
determining a distribution of an offset between the completion of work at a last component of the transaction path and a time of reporting said work at the last component of the transaction path; and
combining distributions of component elapsed times and collective distributions of component offsets to calculate the transaction lag for each component in the transaction path.

2. The computer-implemented method of claim 1 wherein determining the transaction path for groups of transactions comprises sorting the transaction paths in reverse topological order.

3. The computer-implemented method of claim 1 further comprising integrating delays between components into the method by inserting the delay as a component between any of the other components and measuring it accordingly.

4. The computer-implemented method of claim 1 wherein determining the transaction path comprises implementing a workflow directed acyclic graph with the components represented as vertices, wherein the directed acyclic graph is annotated with corresponding elapsed times.

5. The computer-implemented method of claim 4 further comprising computing the elapsed times dynamically.

6. The computer-implemented method of claim 4 further comprising sorting the vertices in reverse topological order.

7. The computer-implemented method of claim 6 further comprising traversing the vertices in the reverse topological order.

8. The computer-implemented method of claim 7 further comprising performing alternating iterations of:
obtaining the elapsed time of a current vertex; and
using the elapsed time of a current vertex to update the transaction lag of the current vertex's immediate upstream vertices.

9. The computer-implemented method of claim 8 further comprising
locating the elapsed time using transaction lags of downstream vertices.

10. The computer-implemented method of claim 8 further comprising locating the elapsed time using transaction lags of any other data that can be used to derive the elapsed time.

11. A computer program product embodied on a computer readable storage medium and comprising code that, when executed, causes a computer to perform the following:
determine a transaction path for groups of transactions in a plurality of transactions to be processed;
determine a distribution of elapsed times from a start of work at each component to an end of work at each component, for the plurality of the components in the transaction path;
determine a distribution of the offset between the completion of work at the last component of the transaction path and the time of reporting the work at the last component of the transaction path; and
combine the distributions of component elapsed times and the collective distributions of component offsets to calculate the transaction lag for each component in the transaction path.

12. The computer program product of claim 11 wherein the code further causes the computer to sort the transaction paths in reverse topological order.

13. The computer program product of claim 11 wherein the code further causes the computer to integrate a delay between the components into the determination by inserting the delay as a component between any of the other components and measuring it accordingly.

14. The computer program product of claim 11 wherein the computer readable storage medium is an application specific integrated circuit.
